(19) United States
(12) Patent Application Publication
(10) Pub. No.: US 2017/0273475 A1
(43) Pub. Date: Sep. 28, 2017

(54) VIBRATION DEVICE FOR BEDS

(71) Applicant: Halo Innovations, Inc., Minnetonka, MN (US)

(72) Inventors: William Schmid, Minnetonka, MN (US); Paul Goudreau, Minnetonka, MN (US); Ian Forte, Minnetonka, MN (US)

(21) Appl. No.: 15/468,589

(22) Filed: Mar. 24, 2017

Related U.S. Application Data
(60) Provisional application No. 62/396,492, filed on Sep. 19, 2016.
(60) Provisional application No. 62/313,324, filed on Mar. 25, 2016.

(51) Int. Cl. A47D 15/00; H04R 1/02; F21S 9/03; A47D 9/04; F21V 23/04

(52) U.S. Cl. CPC A47D 15/001; A47D 9/04; F21V 23/04; F21S 9/03; H04R 1/028

(57) ABSTRACT

Vibration devices are described that provide soothing movement or motion to a person, such as an infant or toddler, laying in a bed. The vibration devices are not part of, but are separately attachable to/removable from, the bed. The vibration devices utilize a control section that is outside the bed and a passive or active transmission element located underneath the mattress that transfers vibration motion to mattress the person is laying on. The devices described herein may also produce noise resulting from the generated movement that may be soothing to the person laying on the mattress.

### FIELD

This disclosure relates to a device used with an infant or children's bed for soothing and comforting a person laying in the bed.

### BACKGROUND

Parents have long sought ways to comfort and soothe their infants and children when they aren't carrying them in their arms. Subtle movements or motion such as rocking, swaying, and vibration have proven effective at relieving fussiness and apparent discomfort.

### SUMMARY

The vibration devices described herein relate to a means of providing soothing movement or motion to a person laying in a bed via a device that is not part of, but is separately attachable to/removable from, the bed. The vibration devices utilize a control section that is located outside the bed and a passive or active transmission element located underneath the mattress that transfers vibration motion to the mattress or other sleep surface the person is laying on. The vibration devices described herein may also produce noise resulting from the generated movement that may be soothing to the person laying on the mattress or other sleep surface.

In one embodiment, the control section includes an electronic device that can generate vibration such as a motor spinning an eccentric weight or a piezo generator. The vibration generating device can be powered by batteries, low voltage, line voltage or a combination of these power sources. The vibration generating device can be turned ON and OFF with a simple switch on the control section or a remote control and it could have adjustable vibration frequency or intensity controls. In one illustrated example, the control section is spaced away from the crib pickets. This helps to prevent the control section from rattling against the pickets.

The control section is attached to the transmission element which in one embodiment can be a flat, thin, stiff piece of material that can be placed under the mattress. In this embodiment, the transmission element should be flat and thin enough so it doesn't affect the mattresses' comfort, yet flexurally rigid enough to efficiently transmit the vibrations to the mattress and bedframe from the control section.

In one embodiment, a vibration device for soothing a child in a child's bed having a mattress disposed on a mattress support includes a vibration generating device that generates vibrations, a generally flat transmission element that fits underneath the mattress between the mattress and the mattress support that transmits vibrations from the vibration generating device into the mattress, a control section that controls operation of the vibration generating device, and a neck that interconnects the generally flat transmission element and the control section.

In a crib environment it is contemplated that the control section will be located outside the crib's walls and connect to the transmission element which would be shaped to fit between the crib's pickets or slats and extend under the mattress with a wide and long enough footprint to successfully transmit the vibration.

In a toddler bed where the mattress may sit down in a frame that extends up and around the lower portion of the mattress, the transmission element can have a goose-neck between the point where the control section is attached and where the transmission element extends under the mattress. This goose-neck could accommodate the elevation change from the top of the mattress frame to the bottom of the mattress.

In one embodiment, the transmission element extends underneath the mattress via one of the side walls of the crib or the side of the toddler bed which helps to ensure a more uniform distribution of the vibrations. However, in other embodiments, the transmission element could be inserted at one of the longitudinal ends of the crib or toddler bed.

The devices described herein are removable and portable allowing them to be installed on different cribs and toddler beds.

As used herein and in the claims, the term child is intended to encompass an infant and a toddler unless otherwise indicated, up to children approximately 10 years of age, but exclude children that are older than approximately 10 years in age. In one embodiment, an infant is a child ranging in age from a newborn up to about 12 months in age, and a toddler is a child ranging in age from about 12 months in age to about 36 months in age. A child's bed as used herein and in the claims, unless otherwise indicated, is intended to encompass an infant's bed and a toddler's bed. An infant's bed is typically referred to as a crib. The vibration devices described herein can be used with mattresses sized for infant's, sized for toddlers, and twin sized, as well as for larger mattresses such as full, queen or king sized. The term mattress as used herein and in the claims, unless otherwise indicated, refers to any cushioned sleep surface that the child lays on in a bed.

### DRAWINGS

FIG. 1 is a perspective view of a first embodiment of a vibration device described herein.

FIG. 2 is another perspective view of the vibration device of FIG. 1.

FIG. 3 illustrates the positioning of a transmission element of the vibration device of FIGS. 1 and 2 relative to a crib.

FIG. 4 illustrates the control section of the vibration device of FIGS. 1 and 2 located outside the crib pickets of the crib of FIG. 3.

FIG. 5 illustrates the vibration device of FIGS. 1-4 with the transmission element located underneath the crib mattress and the control section outside the crib pickets.

FIG. 6 is a partial sectional view of another embodiment of a vibration device used with a toddler bed.

FIG. 7 is a top view of another embodiment of a vibration device.

FIG. 8 is a side view of the vibration device of FIG. 7.

FIG. 9 is an end view (from the end of the control section) of the vibration device of FIG. 7.

FIG. 10 is a longitudinal side sectional view of the vibration device of FIG. 7.

FIG. 11 is an end view (from the end of the transmission element) of the vibration device of FIG. 7.

FIG. 12 is a perspective view of the vibration device of FIG. 7.

FIG. 13 is another perspective view of the vibration device of FIG. 7.

FIG. 14 illustrates the vibration device of FIGS. 7-13 relative to a crib.

FIG. 15 is a side view of the vibration device of FIGS. 7-13 relative to a crib.

### DETAILED DESCRIPTION

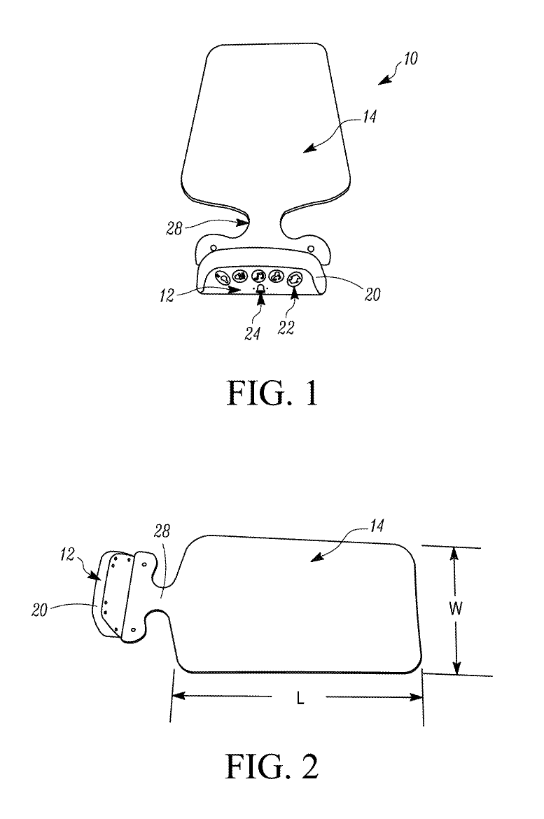

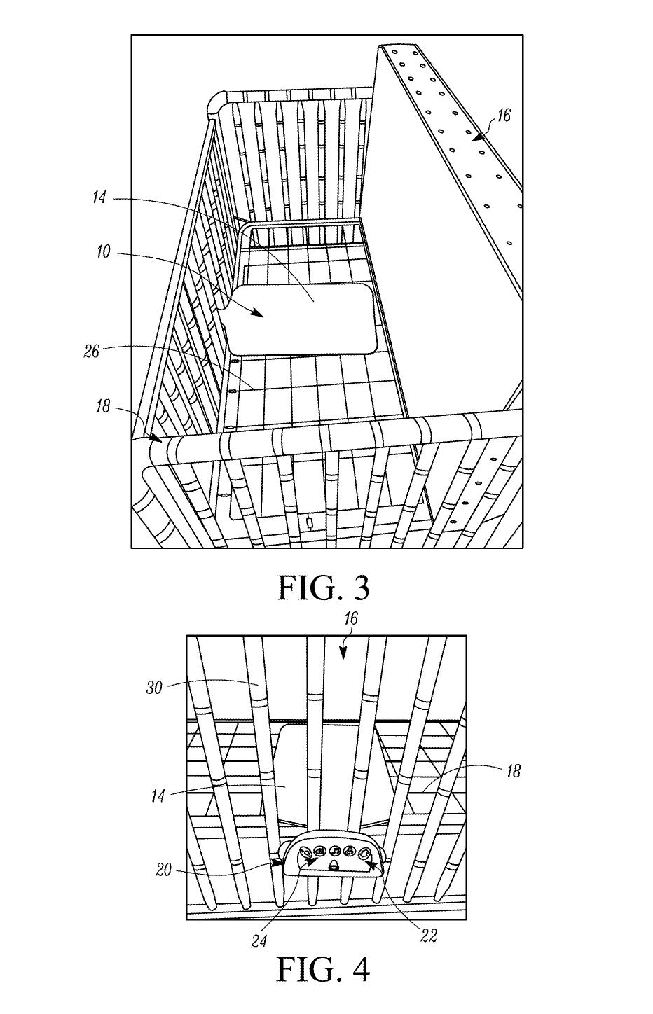

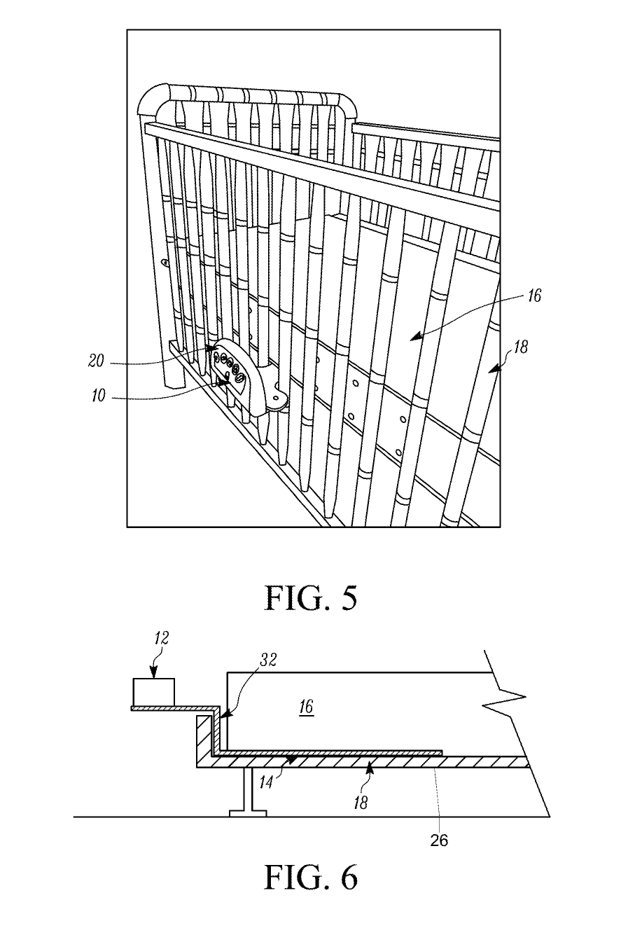

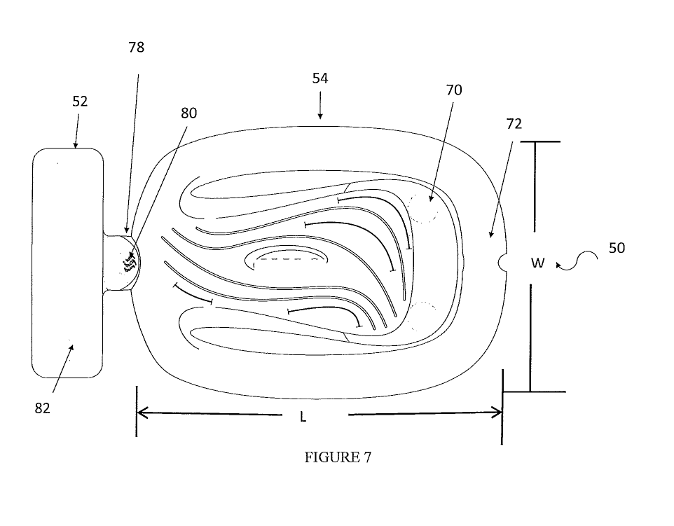

Referring to FIGS. 1-5, a vibration device 10 is illustrated that includes a control section 12 and a transmission element 14 that is attached, permanently or removably, to the control section 12. In this embodiment, the control section 12 is configured to generate vibrations that are transmitted to the transmission element 14 which in turn are transmitted from the transmission element 14 to a mattress 16 (see FIGS. 3-5) and a bedframe 18 (see FIGS. 3-5) such as a crib (shown in FIGS. 3-5) or a toddler bed (shown in FIG. 6).

Referring to FIGS. 1-2, the control section 12 includes a housing 20 that houses a vibration generating device and control electronics for controlling operation of the vibration generating device. Many examples of vibration generating devices are known in the prior art and the vibration generating device can have any configuration suitable for generating vibrations suitable for soothing infant's or children as described herein. Power for powering the vibration generating device can be provided by one or more batteries disposed for example within the housing 20, and/or a solar panel operable under room lighting conditions, and/or other low voltage power source. Alternatively, power for powering the vibration generating device can be provided by line voltage in which case a power cord (not illustrated) can extend from the housing 20 which plugs into a suitable wall outlet.

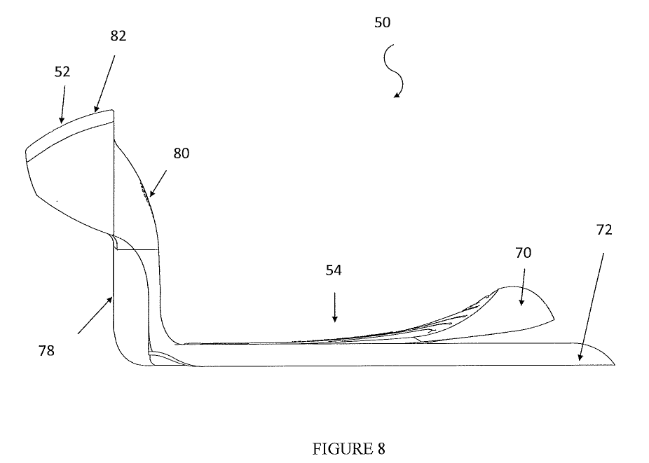

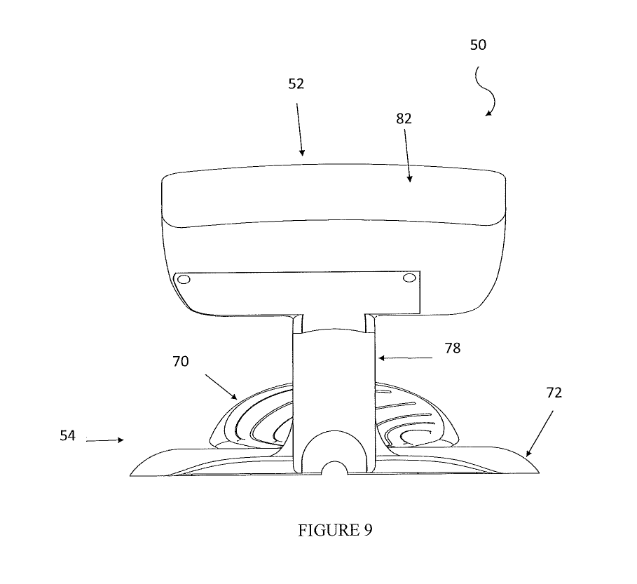

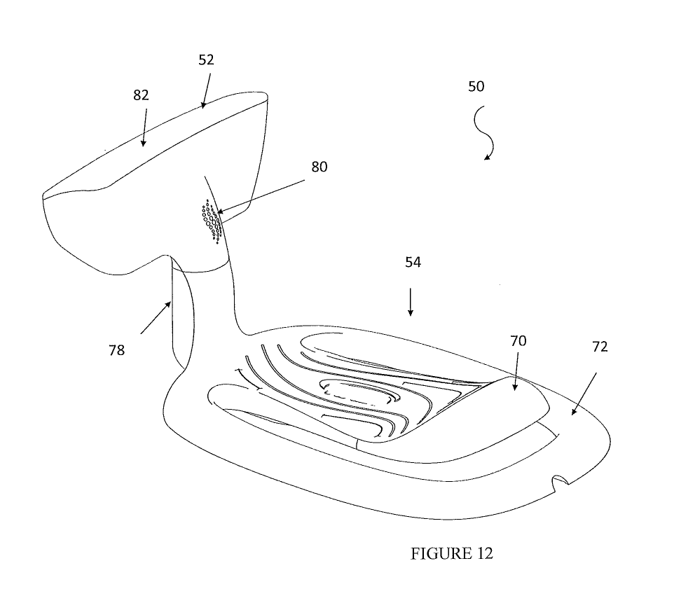

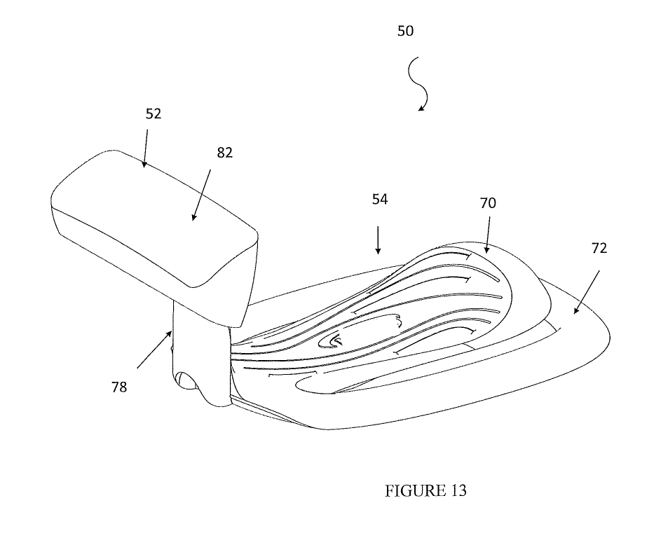

As discussed in more detail below with respect to FIGS. 7-15, the housing 20 can be provided with a control panel 22 having one or more control buttons 24 that control various operations of the vibration device 10. The control buttons 24 can include, but are not limited to, an on/off switch for turning the vibration device 10 on and off which switch can also control operation of the vibration generating device (or a separate on/off switch can be provided to turn the vibration generating device on and off), a switch for increasing or decreasing the intensity of the vibrations generated by the vibration generating device, a switch for controlling one or more night lights on the control section 12 or on a connector that connects the control section 12 to the transmission element 14, a switch for controlling music or other sounds generated by the vibration device 10, and other switches.

The transmission element 14 is a generally flat, planar, plate-like structure that fits under the mattress 16 between the bottom surface of the mattress 16 and a support 26 of the bedframe 18 on which the mattress 16 is supported. The transmission element 14 has a size or an area that is less than the size or area of the mattress 16. In the illustrated example, the transmission element also has a length L that is greater than its width W.

The transmission element 14 is connected to the control section 12 by a neck 28 that also transmits vibrations produced by the control section 12 to the transmission element 14. In the embodiment illustrated in FIGS. 1-5, the vibration device 10 is configured to work with a crib in that the neck 28 of the vibration device 10 is made with a narrowing that allows the neck to fit between the crib's pickets 30 as best seen in FIG. 3, allowing the control section 12 to remain safely outside the sleeping area of the crib. The neck 28 could have soft foam or a padded collar around it to keep the neck 28 centered between the crib pickets 30 and to keep the neck 28 from vibrating against the pickets 30. Alternatively, or additionally, soft foam or padded collars can be provided on the crib pickets 30 near the neck 28. In one embodiment, the transmission element 14 can detachably connect to the neck 28 and the neck 28 can detachably connect to the control section 12. In another embodiment, the neck 28 can be integrally formed with the transmission element 14 and/or with the control section 12.

In this embodiment, the vibration device 10 can be installed by rotating the vibration device 90 degrees so the transmission element 14 is rotated 90 degrees on its longitudinal centerline and sliding the transmission element 14 between two adjoining pickets 30. The vibration device 10 is then rotated 90 degrees back to its original orientation so that the transmission element 14 lays flat on the support 26 when the transmission element 14 is underneath the mattress 16. In another embodiment, the transmission element 14 can be separated from the control section 12, with the two pieces then being reattached between two adjoining pickets 30 once they are disposed on opposite sides of the crib wall.

FIG. 6 illustrates an alternative embodiment of a vibration device that is similar to the vibration device 10 in that the vibration device of FIG. 6 includes the control section 12 and the transmission element 14. However, this embodiment of the vibration device 10 is configured to work with a toddler bed where the mattress 16 is recessed into the bed frame 18. A gooseneck 32 connects the control section 12 to the transmission element 14 to allow the transmission element 14 to fit under the mattress 16 and allow the control section 12 to be conveniently next to the bed as shown in FIG. 6.

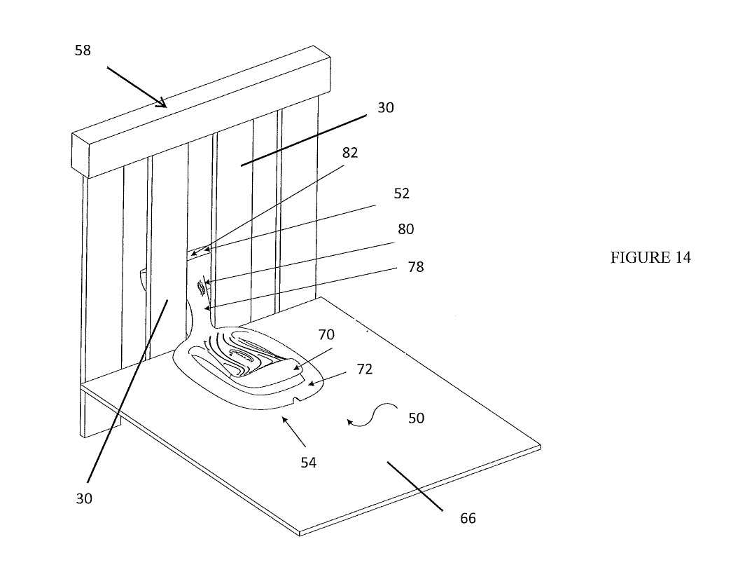

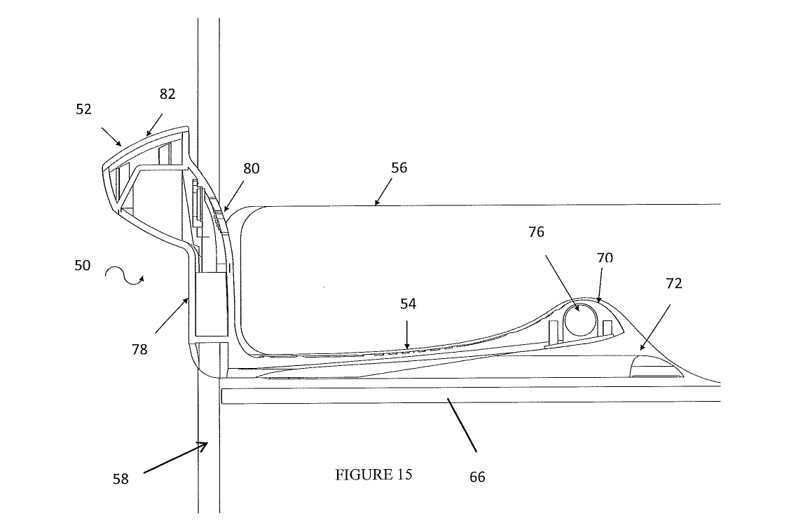

Referring now to FIGS. 7-15, another embodiment of a vibration device 50 is illustrated. The vibration device 50 includes a control section 52 and a transmission element 54 that is attached, permanently or removably, to the control section 52. In this embodiment, the transmission element 54 is configured to generate vibrations using a vibration generating device in the transmission element 54 that are transmitted from the transmission element 54 to a mattress 56 (see FIG. 15) and a bedframe 58 (see FIG. 14-15) such as a crib (shown in FIG. 14) or a toddler bed like shown in FIG. 6. Many examples of vibration generating devices are known in the prior art and the vibration generating device can have any configuration suitable for generating vibrations suitable for soothing infant's or children as described herein.

Referring to FIGS. 7-13, the control section 52 includes a housing 60 that houses control electronics for controlling operation of the vibration device 50. Power for powering the vibration generating device in the transmission element 54 can be provided by one or more batteries disposed for example within the housing 60, and/or a solar panel operable under room lighting conditions, and/or other low voltage power source. Alternatively, power for powering the vibration generating device can be provided by line voltage in which case a power cord (not illustrated) can extend from the housing 60 which plugs into a suitable wall outlet.

The housing 60 can be provided with a control panel 62 having one or more control buttons 64 that control various operations of the vibration device 50. The control buttons 64 can include, but are not limited to, an on/off switch for turning the vibration device 50 on and off which switch can also control operation of the vibration generating device (or a separate on/off switch can be provided to turn the vibration generating device on and off), a switch for increasing or decreasing the intensity of the vibrations generated by the vibration generating device, a switch for controlling one or more night lights on the control section 52 or on a connector that connects the control section 52 to the transmission element 54, a switch for controlling music or other sounds generated by the vibration device 50, and other switches.

The transmission element 54 is a generally flat structure that fits under the mattress 56 (FIG. 15) between the bottom surface of the mattress 56 and a support 66 of the bedframe 58 (FIG. 15) on which the mattress 56 is supported. The transmission element 54 has a size or an area that is less than the size or area of the mattress 56. In the illustrated example, the transmission element also has a length L that is greater than its width W so that some of the transmission element is located near a centerline of the mattress 56.

In the illustrated embodiment, the transmission element 54 includes a vibration lever 70 and a supporting board 72. The vibration lever 70 can be integrally formed with the supporting board 72 at an end 74 thereof nearest to the control section 52. At the other end of the transmission element 54, the vibration lever 70 is free of and not connected to the supporting board 72 and the free end can be spaced apart from the supporting board 72 a small distance.

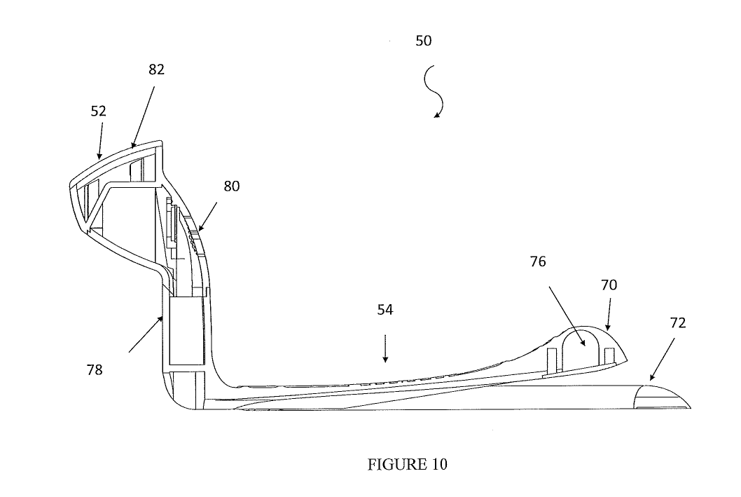

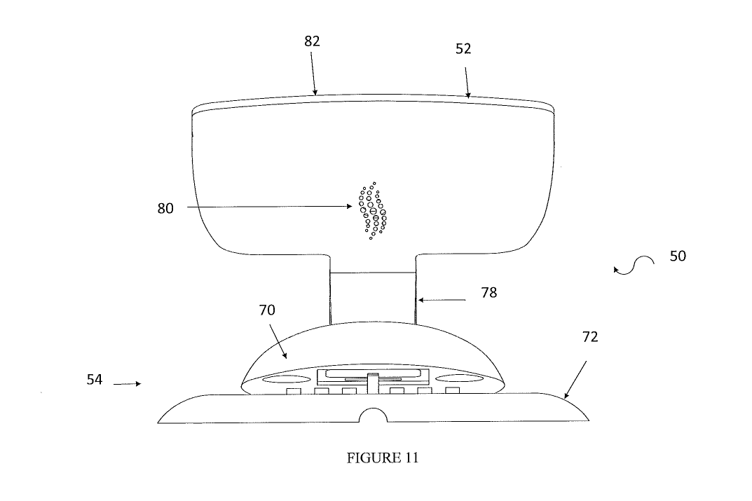

Referring to FIG. 10, the vibration generating device 76 can be provided in the vibration lever 70, for example at or near the free end thereof where the vibration lever 70 is spaced away from the supporting board 72. In this embodiment, the vibration lever 70 provides increased vibration by having the vibration generating device 76 located directly under the mattress 16, yet not contacting the mattress support 66 for quieter operation. By locating the vibration generating device in the vibration lever 70, the vibrations are accentuated allowing the use of a smaller vibration generating device 76, or a vibration generating device 76 that requires less power, etc.

In other embodiments, the vibration generating device 76 can be located and/or mounted elsewhere in the transmission element 54 of FIGS. 7-15. The vibration generating device 76 can also be mounted within a flat transmission element like the transmission element 14 of FIGS. 1-6 without the vibration lever 70. In addition, the vibration generating device 76 can also be mounted in the control section 52 like in the device of FIGS. 1-6.

The transmission element 54 is connected to the control section 52 by a neck 78, such as a goose neck in the illustrated embodiment. In the embodiment illustrated in FIGS. 7-15, the vibration device 50 is configured to work with a crib in that the neck 78 of the vibration device 50 is made narrow that allows the neck 78 to fit between the crib's pickets 30 as best seen in FIG. 14, allowing the control section 52 to remain outside the sleeping area of the crib. The neck 78 could have soft foam or a padded collar around it to keep the neck 78 centered between the crib pickets 30 and to keep the neck 78 from vibrating against the pickets 30. Alternatively, or additionally, soft foam or padded collars can be provided on the crib pickets 30 near the neck 78. In one embodiment, the transmission element 54 can detachably connect to the neck 78 and the neck 78 can detachably connect to the control section 52.

In an embodiment, the neck 78 connects to the transmission element 54 at or near the point where the transmission element 54 extends under the mattress 56. In some embodiments, the structure and function of the neck 78 of the vibration device 50 in FIGS. 7-15 are substantially the same as illustrated in FIGS. 1-6; the installation and the portability of the vibration device 50 in FIGS. 7-15 are substantially the same as illustrated in FIGS. 1-6; and/or the structure of the transmission element 54 of the device 50 in FIGS. 7-15 excluding the vibration lever 70 can be substantially the same as the transmission element 14 illustrated in FIGS. 1-6.

In some embodiments, the neck 78 can include a sound generating device that provides soothing sounds broadcast through one or more speakers 80 on the vibration device 50, such as on the neck 78. In other embodiments, the sound generating device can be located in the control section 52. In an embodiment, one or more night lights 82 can be located on the control section 52. In another embodiment, one or more night lights can be located on the neck 78.

The vibration devices described herein can be powered by batteries, low voltage, line voltage or a combination of these power sources. The vibration devices described herein can also have adjustable frequency and/or intensity controls for, such as, but not limited to, vibration, sounds, and/or night lights. The vibration devices described herein can also have controls for various colors of the night light and/or various types of sounds. The vibration devices described herein can be controlled by using the control panel or using a remote control that wirelessly connects to the control panel using a suitable wireless connection technology such as Bluetooth, infrared, radio frequency, wi-fi, and the like. The remote control can be a dedicated, programmable remote control unit designed specifically for the vibration device, or application software loaded on a smart device such as a smartphone, tablet or the like. The remote control can be programmed to control operation of the vibration device including, but not limited to, setting duration of functions of the device, sequencing of functions of the device, time-of-day based functions that determine when functions of the device turn on or turn off, and the like.

In this embodiment, the vibration device 50 can be installed by rotating the vibration device 90 degrees so the transmission element 54 is rotated 90 degrees on its longitudinal centerline and sliding the transmission element 54 between two adjoining pickets 30. The vibration device 50 is then rotated 90 degrees back to its original orientation so that the supporting board 72 of the transmission element 54 lays flat on the support 66 when the transmission element 54 is underneath the mattress 56. In another embodiment, the transmission element 54 can be separated from the control section 52, with the two pieces then being reattached between two adjoining pickets 30 once they are disposed on opposite sides of the crib wall.

As shown in FIGS. 14-15, when the vibration device 50 is correctly mounted in position, the control section 52 is located outside the crib's walls, with the neck 78 extending between two pickets 30 to the transmission element 54 which is disposed underneath the mattress 56 between the bottom surface thereof and the support 66.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A vibration device for soothing a child in a child's bed having a mattress disposed on a mattress support, comprising:
a vibration generating device that generates vibrations;
a generally flat transmission element that fits underneath the mattress between the mattress and the mattress support, the generally flat transmission element transmits vibrations from the vibration generating device into the mattress;
a control section that controls operation of the vibration generating device; and
a neck that interconnects the generally flat transmission element and the control section.

2. The vibration device of claim 1, wherein the vibration generating device is disposed in the generally flat transmission element.

3. The vibration device of claim 2, wherein the generally flat transmission element includes a supporting board and a vibration lever connected at one end thereof to the supporting board, and the vibration generating device is disposed in the vibration lever.

4. The vibration device of claim 3, wherein vibration generating device is disposed in the vibration lever at an end thereof opposite the one end connected to the supporting board.

5. The vibration device of claim 1, wherein the vibration generating device is disposed in the control section.

6. The vibration device of claim 1, wherein the child's bed is a crib with spaced pickets defining a side wall of the crib, and the neck is sized to fit between two adjacent pickets wherein in use the control section is disposed outside the crib.

7. The vibration device of claim 1, wherein the neck comprises a gooseneck.

8. The vibration device of claim 1, further comprising foam padding on the neck.

9. The vibration device of claim 1, wherein the control section includes a control panel with an on/off switch that controls operation of the vibration generating device.

10. The vibration device of claim 9, further comprising at least one of a night light and a speaker.

11. The vibration device of claim 9, further comprising a speaker disposed on the neck.

12. The vibration device of claim 1, further comprising at least one battery in the control section providing power to the vibration generating device.
